(19) United States
(12) Patent Application Publication
(10) Pub. No.: US 2005/0204786 A1
(43) Pub. Date: Sep. 22, 2005

(54) Pin-capturing cable lock for securing a computer

(76) Inventors: Christopher E. Meyer, Fountain Valley, CA (US); John W. Waguespack, Redondo Beach, CA (US)

Correspondence Address: STETINA BRUNDA GARRED & BRUCKER, 75 ENTERPRISE, SUITE 250, ALISO VIEJO, CA, 92656, US

(21) Appl. No.: 10/805,861

(22) Filed: Mar. 22, 2004

(51) Int. Cl. E05B 69/00; E05B 73/00

(52) U.S. Cl. 70/58

(57) ABSTRACT

There is provided a lock device adapted to secure a computer having a protruding member. This lock device features a lock housing having a capturing channel which is sized and configured to receive the protruding member extending outwardly from the computer. The lock device also features a lock member that is attached to the lock housing. The lock member has a lock portion sized and configured to extend to the capturing channel for retaining the protruding member therewithin so as to secure the computer.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates generally to theft prevention devices, and more particularly to a lock device which is adapted to capture and retain a metallic pin extending from a computer such as a laptop computer so as to secure and prevent the theft of the computer.

Computers are becoming more miniaturized but yet more powerful everyday. This is exemplified by the introduction of laptop computers and smaller computer hardware such as flat screen monitors. Although such miniaturization of computers and computer hardware has increased the convenience of their use, it also increased the possibility of their theft. This poses to be a great problem to their purchasers who have spent significant sums of money for them.

In order to protect computers and computer hardware from theft, various types of anti-theft computer locks have been developed and are currently sold in the marketplace. One type of anti-theft computer lock currently dominating the marketplace is a cable lock such as MicroSaver® Notebook Security Cable or Twin MicroSaver® from Kensington Microware Limited of San Mateo, Calif. which is designed to engage a slot formed within a computer. However, although such anti-theft computer lock may generally accomplish its intended objective of preventing computer theft, it nonetheless possesses certain deficiencies which detract from its overall utility in protecting ever miniaturizing computers and computer hardware.

Perhaps the greatest deficiency of such slot-engaging anti-theft computer locks is the discontinuation of technological innovations in computer theft prevention. For years, these computer locks are designed to engage and interlock only one oval-shaped security slot that is formed within the computers. This has been a required specification which consistently defined the slot-engaging computer locks in the past and still continues to this very day. As such, the technological advances in the computer lock industry have been virtually minimal unlike the overall development in computer technology. Simply put, there has not been continual innovations in computer lock industry in pace with the ever advancing technology in the field of computers.

Further deficiency in the existing slot-engaging anti-theft computer locks lies in the cables that they use. Typically, the cables are fixedly attached to and extended from the computer locks at the portions which are opposite from their slot-engaging portions. Because the cables are fixedly attached to the anti-theft computer locks, the portions of cables near such attachment points may become locally strained if the cables are lassoed around stationary objects which are placed in angular orientations with respect to the computer locks. Unless the cable is generously long enough and/or lassoed around an object which is placed substantially next to the slot-defining side of the computer, the strained portions of the cable may cause lightly weighted computers such as laptops to be unstably or unevenly maintained on a flat surface such as a desktop. Additionally, the wear and tear on such portions may be far greater than the rest of the cable.

In view of the above-described shortcomings of conventional anti-theft computer locks, there exists a need in the art for a lock device that can effectively prevent theft of a computer and/or computer hardware in a more unique and innovative manner than merely engaging one oval-shaped security slot formed within the computer. Moreover, there exists a need for a lock device which can mitigate its cable from becoming locally strained at the cable portion adjacent the lock device irrespective of the angular orientation of the stationary object's placement with respect to the lock device.

### BRIEF SUMMARY OF THE INVENTION

The present invention specifically addresses and alleviates the above-referenced deficiencies associated with the use of the anti-theft computer locks of the prior art. In accordance with a preferred embodiment of the present invention, there is provided a lock device adapted to secure a computer having a protruding member. This lock device features a lock housing having a capturing channel which is sized and configured to receive the protruding member extending outwardly from the computer. The lock device also features a lock member that is attached to the lock housing. The lock member has a lock portion sized and configured to extend to the capturing channel for retaining the protruding member therewithin so as to secure the computer.

More specifically, the capturing channel has a receiving channel portion and a capturing channel portion. The receiving channel portion is sized and configured to receive the protruding member therethrough. The capturing channel portion is sized and configured to engage the protruding member when the protruding member slides thereto from the receiving channel portion. The capturing channel defines an interior channel surface. The interior channel surface may have a capturing flange formed generally around the capturing channel portion to narrow the capturing channel thereabout so as to frictionally engage the protruding member about the capturing channel portion.

In the preferred embodiment of the present invention, the lock housing has a locking channel in communication with the capturing channel and extending generally perpendicular thereto. The lock portion is disposed within the locking channel and has a lock engaging portion configured to extend into the capturing channel for retaining the protruding member within the capturing channel so as to secure the computer. More particularly, the lock engaging portion may be extendable into the receiving channel portion and be maintainable thereabout when the protruding member is placed about the capturing channel portion.

In accordance with the preferred embodiment of the present invention, the lock device further comprises an elongated securing member. In order to accommodate such securing member, the lock housing has a securing channel extending generally perpendicular to the capturing channel. Specifically, the securing member has a securing end which is configured to be contained within the securing channel and be movable therealong. Preferably, the elongated securing member is a cable that is sized and configured to secure the computer to a stationary object.

In the preferred embodiment of the present invention, the protruding member has a protruding body and a protruding head, wherein the protruding head may be generally larger in diameter than the protruding body. As such, the receiving channel portion may be sized to correspond to the protruding head so as to allow the protruding head to be received therethrough. Furthermore, the capturing channel portion may be sized to correspond to the protruding body so as to allow the protruding body to be engaged therewithin. The protruding member extends outwardly from a body of a computer such as a laptop computer. Preferably, the protruding member is a pin which is fabricated from a metallic material. In one embodiment, the protruding member is fixedly attached to the computer body.

In a different embodiment, the protruding member is movably attached to the computer body. More specifically, the protruding member may be movable away from the computer body for forming an extended position when engaging the capturing channel. Additionally, the protruding member may be movable toward the computer body for forming a retracted position when engagement to the capturing channel is not necessitated. The protruding head may be disposed in a substantially flush relationship with the computer body when the retracted position is formed.

In the latter embodiment, the protruding member may be threadably attached through the computer body. This configures the protruding member to be threaded outward from the computer body to form the extended position and threaded inward toward the computer body to form the retracted position.

In the alternative, the protruding member may be spring loaded within the computer body. This configures the protruding member to spring outward from the computer body via a spring force when forming the extended position. Moreover, the protruding member may be configured to be maintained within the computer body against the spring force when forming the retracted position.

### BRIEF DESCRIPTION OF THE DRAWINGS

These as well as other features of the present invention will become more apparent upon reference to the drawings wherein:

FIG. 1 is a perspective view of a computer lock device constructed in accordance with a preferred embodiment of the present invention and illustrating its capturing channel which is adapted to receive and retain a protruding member of a computer therewithin;

FIG. 2A is a perspective view of a protruding member of a computer constructed in accordance with a first preferred embodiment of the present invention;

FIG. 2B is a cross-sectional view of the protruding member of FIG. 2A and illustrating the manner in which it is fixedly or permanently engaged to a body of the computer;

FIGS. 3A and 3B are perspective views of a protruding member of a computer constructed in accordance with a second preferred embodiment of the present invention;

FIGS. 3C and 3D are cross-sectional views of the protruding member of FIGS. 3A and 3B and illustrating the manner in which it is threadably engaged to a body of the computer;

FIGS. 4A and 4B are cross-sectional views of a protruding member of a computer constructed in accordance with a third preferred embodiment of the present invention and illustrating the manner in which it is spring loaded to a body of the computer;

FIG. 5 is a cross-sectional view of the computer lock device of FIG. 1 and illustrating its lock member which extends to the capturing channel for retaining the protruding member of the computer therewithin; and

FIG. 6 is a cross-sectional view of the computer lock device of FIG. 1 and illustrating its lock member which retracts from the capturing channel for releasing the protruding member of the computer therefrom.

### DETAILED DESCRIPTION OF THE INVENTION

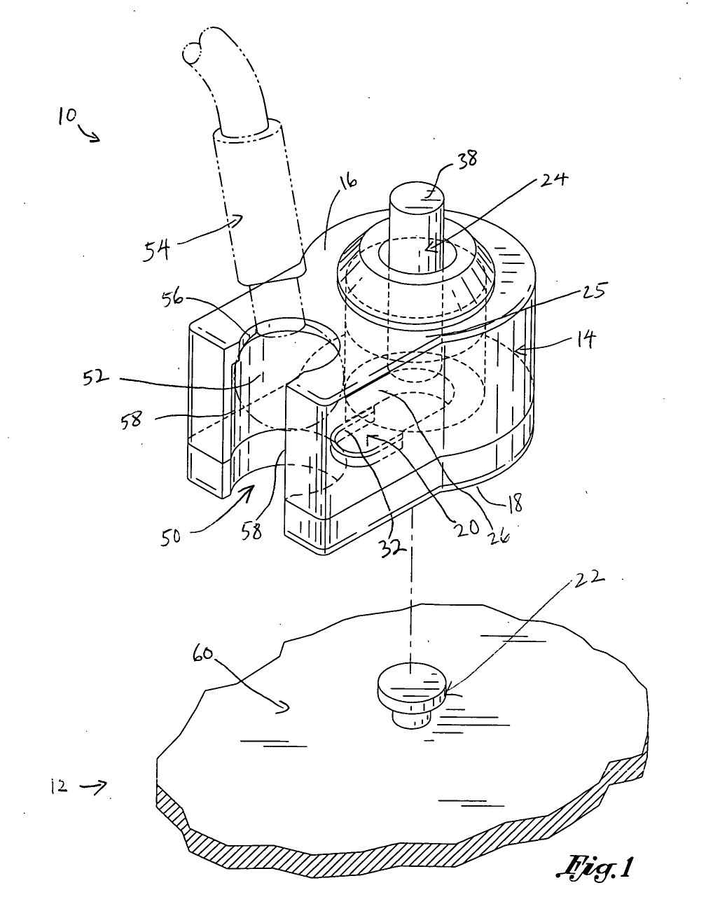

Referring now to the drawings wherein the showings are for purposes of illustrating preferred embodiments of the present invention only, and not for purposes of limiting the same, FIG. 1 perspectively illustrates a lock device 10 constructed in accordance with a preferred embodiment of the present invention. The lock device 10 is adapted to secure a computer 12 such as a laptop computer to a stationary object (not shown) in order to effectively prevent the theft of the computer 12. However, it should be expressly contemplated herein that the lock device 10 of the present invention may also be utilized to secure individual parts of a desktop computer (e.g., a monitor, a computer mainframe, etc.) and various other electronic apparatuses such as telephones, televisions and the like by using the principles which are described below.

Referring more particularly to FIGS. 1, 5 and 6, the lock device 10 of the present invention first features a lock housing 14 which may be formed to have a variety of shapes, configurations, geometries and textures. Although the lock housing 14 is shown in the provided figures as having a generally rectangular configuration, it is understood that the lock housing 14 as depicted is symbolic in nature. Furthermore, the lock housing 14 may be constructed from any rigid material such as plastic or metal (e.g., hardened steel or zinc alloy).

The lock housing 14 defines a first housing surface 16 and a second housing surface 18. Disposed about the second housing surface 18 is a capturing channel 20. The capturing channel 20 is sized and configured to receive a protruding member 22 which extends outwardly from the computer 12. The aspect of the protruding member 22 will be described in detail shortly below. Moreover, the lock device 10 further features a lock member 24 which is movably disposed within the lock housing 14 while forming a generally perpendicular relationship with respect to the capturing channel 20. As will be explained below, this lock member 24 includes a lock portion 25 that is adapted to extend into the capturing channel 20 so as to retain the protruding member 22 within such channel 20, thereby effectively securing the computer 12.

The capturing channel 20 includes an interior channel surface 26, and further comprises a receiving channel portion 28 and a capturing channel portion 30. Specifically, the receiving channel portion 28 is sized and configured to receive the protruding member 22 therethrough. The capturing channel portion 30, on the other hand, is sized and configured to engage the protruding member 22. Such engagement takes place when the protruding member 22 slides to the capturing channel portion 30 from the receiving channel portion 28.

To optimize the capturing channel portion's engagement of the protruding member 22, the interior channel surface 26 of the capturing channel 20 preferably comprises a capturing flange 32 which is formed generally around the capturing channel portion 30. By providing the capturing flange 32 around the capturing channel portion 30, it narrows the capturing channel 20 about its capturing channel portion 30. Such narrowing of the capturing channel portion 30 allows the protruding member 22 of the computer 12 to be frictionally engaged, and hence effectively retained, therewithin.

As illustrated in FIGS. 1, 5 and 6, the lock housing 14 further includes a locking channel 34 which extends from about the first housing surface 16 toward the second housing surface 18 so as to be placed in communication with the capturing channel 20. In this regard, the extension of the locking channel 34 is generally perpendicular to the extension of the capturing channel 20. The lock member 24 is movably positioned within the locking channel 34 such that its lock portion 25 becomes disposed within the locking channel 34 and is also movable therealong. The lock portion 25 defines a lock engaging portion 36 which extends into the capturing channel 20 when the protruding member 22 needs to be retained within the capturing channel 20 in order to secure the computer 12.

More particularly, the lock engaging portion 36 extends into the receiving channel portion 28 and be maintained thereabout when the protruding member 22 is moved or slid to the capturing channel portion 30. In this respect, the lock member 25 preferably has a generally cylindrical configuration which substantially corresponds in size and shape to the receiving channel portion 28 so as to immobilize the protruding member 22 at the capturing channel portion 30. Further to such description, it should be noted herein that the lock member 25 may be fabricated from any type of rigid material such as plastic or metal (e.g., hardened steel or zinc alloy).

As specifically illustrated in FIGS. 5 and 6, the lock member 24 may be pushed down from about the first housing surface 16 in the direction of the second housing surface 18 to extend its lock engaging portion 36 within the locking channel 34. Upon such extension, the lock engaging portion 36 of the lock member 24 becomes situated within the receiving channel portion 28 to retain the protruding member 22 of the computer about the capturing channel portion 30. In order to release the protruding member 22 from the lock device 10 of the present invention, the lock engaging portion 36 may be retracted back in the opposite direction of its extension, that is, toward the first housing surface 16 and away from the second housing surface 18. The lock member 24 is preferably spring loaded within the locking channel 34 so that it is naturally biased in the retracted position. As mentioned before, the lock member 24 is a movable piece which may be extended and retracted within the locking channel 34 of the lock housing 14.

More specifically, the lock member 24 defines a push-in end 38 which is exposed out of the lock housing 14 through its first housing surface 16 when the lock member 24 is naturally positioned in the retracted position. To move the lock member 24 from its retracted position to its extended position, the push-in end 38 is preferably pushed in manually towards the second housing surface 18. This in turn causes the lock engaging portion 36 to slide within the locking channel 34 along the same direction and be extended into the receiving channel portion 28 of the capturing channel 20. Of course, such phenomenon should occur after the protruding member 22 is captured within the capturing channel portion 30 of the capturing channel 20. In the preferred embodiment of the present invention, such task is done against the spring force of a compression spring 40 provided within the locking channel 34. Once pushed in, a lateral protrusion 42 which protrudes into the locking channel 34 becomes caught in the locking groove portion 44 of the locking member 24. This allows the lock member 24 to be maintained in the extended position against the force of the compression spring 40.

In order to move the lock member 24 back into the retracted position to thereby disengage the lock engaging portion 36 from the receiving channel portion 28, a specifically configured key 46 which corresponds with the key notches 48 provided within the locking channel 34 is preferably used. Such key 46 is inserted into the locking channel 34 in order to securely mate with the key notches 48 wherein the twisting action of the key 46 would cause the lateral protrusion 42 to dislodge from the locking groove portion 44 of the lock member 24. Once the lateral protrusion 42 becomes dislodged, the lock member 24 can reflex back to the retracted position due to the action of the compression spring 40. This causes the lock engaging portion 36 of the lock member 24 to disengage from the receiving channel portion 28 of the capturing channel 20.

As briefly mentioned above, the objective of the present lock device 10 is to secure a computer 12 such as a laptop computer to a stationary object. To achieve this end, the lock housing 14 defines a securing channel 50 between the first and second housing surfaces 16, 18. Preferably, the securing channel 50 extends along one particular side of the lock housing 14. The securing channel 50 may be extended along either side of the lock housing 14, and it is strictly a manufacturing choice to extend the securing channel 50 along one particular side of the lock housing 14 over the other. As will be explained below, the securing channel 50 should possess sufficient spacing to accommodate a securing end 52 of an elongated securing member 54 and allow it to freely move within the confines formed thereby.

Referring now to FIGS. 5 and 6, the lock housing 14 comprises a first end-containing portion 56 and a side end-containing portion 58 in order to jointly contain the securing end 52 of the elongated securing member 54 within the securing channel 50. Essentially, these end-containing portions 56, 58 are sized and configured to collectively place a physical restraint on the boundaries of the securing channel 50 so as to retain the securing end 52 subsequent to its accommodation therewithin.

In one embodiment, the first end-containing portion 56 may be situated within the securing channel 50 itself immediately adjacent the first housing surface 16 of the lock housing 14. In this configuration, the first end-containing portion 56 would be formed as an integral part of the lock housing 14 and is shaped as a protrusion that extends inwardly into the securing channel 50. Such extension should not completely seal off the securing channel 50 at the first housing surface 16 since the securing member 54 must be able to pass therethrough. However, it should be sufficiently extended to partially close off the securing channel 50 thereat to prevent the securing end 52 from slipping out of the securing channel 50.

In a different embodiment, the first end-containing portion 56 may be formed outside of the securing channel 50. Similar to the above embodiment, this version of the first end-containing portion 56 is likewise an inward protrusion that narrows the securing channel 50 at the first housing surface 16 of the lock housing 14. This also serves as an effective measure which can prevent the securing end 52 from slipping out of place and disengaging from the lock housing 14.

The side end-containing portion 58 is adapted to partially close off the securing channel 50 along the side of the lock housing 14. Although such portion 58 may be defined as various external and/or retrofittable structural configurations that can partially close off the securing channel 50, it is preferably formed as integral parts of the lock housing 14 that extend toward each other to partially close off the securing channel 50. Like the first end-containing portion 56, the extension of side-end containing portion 58 should not be to a degree where it completely closes off the securing channel 50 from the side of the lock housing 14. Rather, it should only partially close off the securing channel 50 as the elongated securing member 54 must be allowed to transition substantially between the first and second housing surfaces 16, 18 along the side of the lock housing 14.

The securing end 52 of the elongated securing member 54 is inserted into the securing channel 50 through the second housing surface 18 of the lock housing 14. After such insertion, the second housing surface 18 is placed against the body 60 of the computer 12, preferably in abutting contact, to make it impossible for the securing channel 50 to be accessed through that surface 18. After closing off the securing channel 50 at the second housing surface 18 in such a manner, the securing end 52 is now physically restrained within the securing channel 50 by the first and side end-containing portions 56, 58 and the body 60 of the computer 12. Such physical confinements would collectively prevent the securing end 52 from slipping out of the securing channel 50 unless the computer body 60 is removed away from the second housing surface 18.

After engaging the lock housing 14 through the use of its securing channel 50, the securing end 52 should be able to slidably move along the securing channel 50 to allow the securing member 52 to be extended in various orientations with respect to the lock housing 14. More specifically, the elongated securing member 54 may be extended from any points defined along the side of the lock housing 14 whereat its securing end 52 may subsequently be moved toward the first housing surface 16 so as to enable the securing member 54 to extend outwardly therefrom. This allows the elongated securing member 54 to be extended either substantially parallel or perpendicular to the body 60 the computer 12.

In order to allow the securing member 54 and its securing end 52 to be mobile, a portion 62 of the securing member 54 immediately adjacent the securing end 52 should be particularly sized in a manner as to slidably fit between the first and side end-containing portions 56, 58. The securing end 52, however, must portray a sufficient size and configuration which would prevent it from coming out of the securing channel 50. Although many configurations are available for such purpose, it is preferred that the securing end 52 has a generally bulbous configuration, and possesses a size which is bigger than the cable portion 62 and which would further prevent the securing end 52 from slipping out through the first and side end-containing portions 56, 58. In addition, the elongated securing member 54 is preferably a lengthened cable configured to lasso around a stationary object. Such cable may be fabricated from any rigid materials. However, metal such as steel is the material of choice for its fabrication.

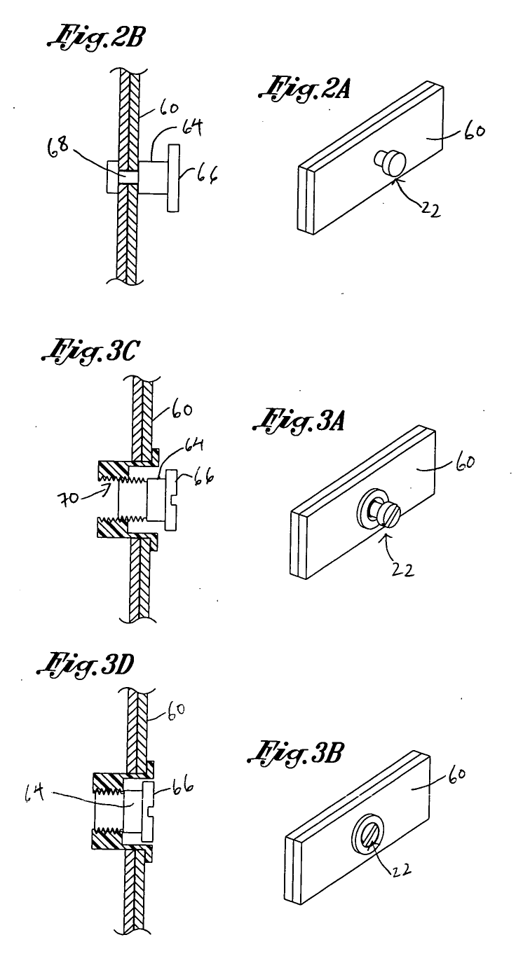

FIGS. 2A-4B illustrate the various manners in which the protruding member 22 may be extended from the body 60 of the computer 12. But first, with respect to the protruding member 22 itself, it has a protruding body 64 and a protruding head 66. Although the protruding member 22 may be formed to define any type of configuration, the protruding head 66 is preferably generally larger in diameter than the protruding body 64. By possessing such configuration, the protruding head 66 is substantially sized to correspond with the receiving channel portion 28 so that it can be inserted therethrough. Furthermore, the protruding body 64 is substantially sized to correspond with the capturing channel portion 30 in order to allow the protruding body 64 to be engaged therewithin, preferably frictionally. As stated previously, the protruding member 22 extends outwardly from the body 60 of the computer 12 such as a laptop computer. Preferably, the protruding member 22 is a pin which is fabricated from a metallic material such as steel.

Referring more particularly to FIGS. 2A and 2B, the protruding member 22 is fixedly attached with the body 60 of the computer 12. In this first embodiment, the protruding member 22 is permanently mounted in a fixed position through the body 60 of the computer 12 such as its chassis. For such fixed positioning, the protruding body 64 of the protruding member 22 may form a body indentation 68 therearound which can securely accommodate or catch the computer body 60 such as its chassis therewithin. This may be accomplished through such accommodation alone, or via the use of an adhesive such as bond or glue to strengthen the fixed engagement. Of course, the protruding member 22 extends outward from the body 60 of the computer 12 in a manner as to subject its protruding head 66 toward the present lock device.

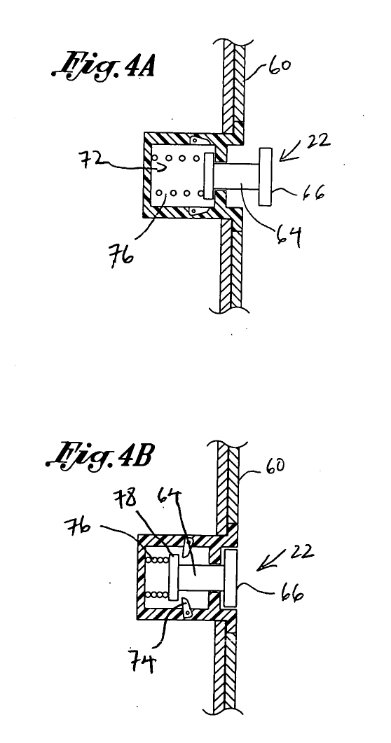

Referring now to FIGS. 3A-3D, there is shown an alternate embodiment in which the protruding member 22 is attached to the computer body 60. In this alternative embodiment, the protruding member 22 is movably engaged to the computer body 60 so that it can be extended out therefrom when in use and be retracted therewithin when not in use. Preferably, the protruding member 22 is threadably engaged to the computer body 60 such as it is manually threaded outward for use and manually threaded inward for non-use. For such engagement, a substantial portion of the protruding body 64 is formed to define a threaded configuration which corresponds to the threaded receptacle 70 lodged within the body 60 of the computer 12. By configuring the protruding body 64 with the threaded receptacle 70, the protruding member 22 can be extended outward with respect thereto by unscrewing until it reaches a proper extension (best shown in FIG. 3A). Likewise, it can be screwed in the opposite direction toward the threaded receptacle 70 until the protruding head 66 of the protruding member 22 becomes substantially flushed with the body 60 of the computer 12 (best shown in FIG. 3B).

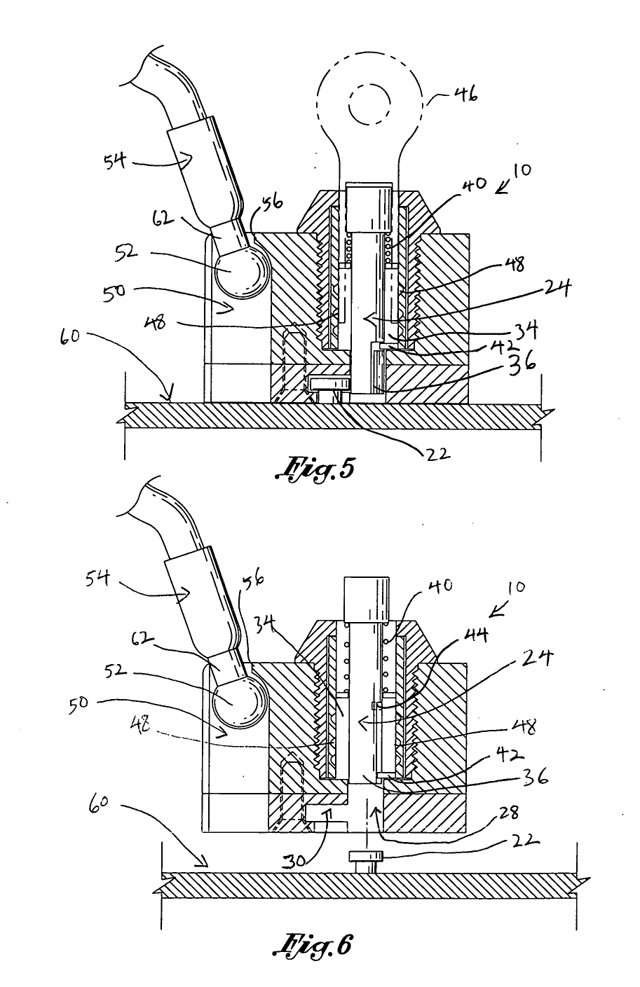

FIGS. 4A and 4B illustrate still a further alternate embodiment in which the protruding member 22 is engaged with the computer body 60. The concept in this third embodiment is similar to the second embodiment in that the protruding member 22 is movably engaged to the computer 60. However, the manner of movable engagement is different. Rather than threadably engaging the protruding member 22 with the computer body 60 through the use of the threaded receptacle 70, the protruding member 22 in this third embodiment is spring loaded. More specifically, a spring receptacle 72 is provided through the body 60 or the chassis of the computer body 60 in which the protruding body 64 is received therein. Upon extension, the protruding body 64 is released by the pin releasers 74 within the spring receptacle 72 and pushed out by the loaded spring 76 to a predetermined distance. Such occurrence may be initiated simply by pressing the protruding head 66 which operates to release the pin releasers 74 from the corresponding body extensions 78 of the protruding body 64. For retraction, the protruding member 22 can be manually pushed into the spring receptacle 72 against the force of the loaded spring 76 wherein the body extensions 78 of the protruding body 64 then catches the pin releasers 74. This retains the protruding member 22 within the spring receptacle 72, preferably in a manner such that its protruding head 66 is substantially flush with the body 60 of the computer 12.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

1. A lock device adapted to secure a computer having a protruding member, the lock device comprising:
a lock housing having a capturing channel sized and configured to receive the protruding member extending outwardly from the computer; and
a lock member attached to the lock housing and having a lock portion sized and configured to extend to the capturing channel for retaining the protruding member therewithin so as to secure the computer.

2. The lock device of claim 1 wherein the capturing channel has a receiving channel portion and a capturing channel portion, the receiving channel portion being sized and configured to receive the protruding member therethrough, the capturing channel portion being sized and configured to engage the protruding member when the protruding member slides thereto from the receiving channel portion.

3. The lock device of claim 2 wherein the capturing channel defines an interior channel surface, the interior channel surface having a capturing flange formed generally around the capturing channel portion to narrow the capturing channel thereabout so as to frictionally engage the protruding member about the capturing channel portion.

4. The lock device of claim 2 wherein the protruding member has a protruding body and a protruding head, the protruding head being generally larger in diameter than the protruding body, the receiving channel portion being sized to correspond to the protruding head so as to allow the protruding head to be received therethrough, the capturing channel portion being sized to correspond to the protruding body so as to allow the protruding body to be engaged therewithin.

5. The lock device of claim 1 wherein the lock housing has a locking channel in communication with the capturing channel and extending generally perpendicular thereto, the lock portion being disposed within the locking channel and having a lock engaging portion configured to extend into the capturing channel for retaining the protruding member within the capturing channel so as to secure the computer.

6. The lock device of claim 5 wherein the capturing channel has a receiving channel portion and a capturing channel portion, the lock engaging portion being extendable into the receiving channel portion and be maintainable thereabout when the protruding member is placed about the capturing channel portion.

7. The lock device of claim 1 further comprising an elongated securing member and wherein the lock housing has a securing channel extending generally perpendicular to the capturing channel, the securing member having a securing end configured to be contained within the securing channel and be movable therealong.

8. The lock device of claim 7 wherein the elongated securing member is a cable sized and configured to secure the computer to a stationary object.

9. A computer, comprising:
a computer body having a protruding member extending outwardly therefrom; and
a lock device comprising:
a lock housing having a capturing channel sized and configured to receive the protruding member extending outwardly from the computer; and
a lock member attached to the lock housing and having a lock portion sized and configured to extend to the capturing channel for retaining the protruding member therewithin so as to secure the computer.

10. The computer of claim 9 wherein the computer body is a body of a laptop computer.

11. The computer of claim 9 wherein the protruding member is a pin fabricated from a metallic material.

12. The computer of claim 9 wherein the protruding member is fixedly attached to the computer body.

13. The computer of claim 12 wherein the protruding member is movably attached to the computer body, the protruding member being movable away from the computer body for forming an extended position when engaging the capturing channel, the protruding member being movable toward the computer body for forming a retracted position when engagement to the capturing channel is not necessitated.

14. The computer of claim 13 wherein the protruding member has a protruding head, the protruding head being disposed in a substantially flush relationship with the computer body when the retracted position is formed.

15. The computer of claim 13 wherein the protruding member is threadably attached through the computer body, the protruding member being configured to be threaded outward from the computer body to form the extended position, the protruding member being configured to be threaded inward toward the computer body to form the retracted position.

16. The computer of claim 13 wherein the protruding member is spring loaded within the computer body, the protruding member being configured to spring outward from the computer body via a spring force when forming the extended position, the protruding member being configured to be maintained within the computer body against the spring force when forming the retracted position.

17. The computer of claim 9 wherein the capturing channel has a receiving channel portion and a capturing channel portion, the receiving channel portion being sized and configured to receive the protruding member therethrough, the capturing channel portion being sized and configured to engage the protruding member when the protruding member slides thereto from the receiving channel portion.

18. The computer of claim 9 wherein the lock housing has a locking channel in communication with the capturing channel and extending generally perpendicular thereto, the lock portion being disposed within the locking channel and having a lock engaging portion configured to extend into the capturing channel for retaining the protruding member within the capturing channel so as to secure the computer.

19. The computer of claim 18 wherein the capturing channel has a receiving channel portion and a capturing channel portion, the lock engaging portion being extendable into the receiving channel portion and be maintainable thereabout when the protruding member is placed about the capturing channel portion.

20. The computer of claim 9 further comprising an elongated securing member and wherein the lock housing has a securing channel extending generally perpendicular to the capturing channel, the securing member having a securing end configured to be contained within the securing channel and be movable therealong.
